(19) United States
(12) Patent Application Publication
(10) Pub. No.: US 2025/0265336 A1
(43) Pub. Date: Aug. 21, 2025

(54) PRE-DEPLOYMENT DETECTION AND RESPONSE

(71) Applicant: Darktrace Holdings Limited, Cambridge (GB)

(72) Inventors: Ciaran McKey, Cambridge (GB); Mihai Varsandan, Edinburgh (GB); Sam Rogers, Suffolk (GB)

(21) Appl. No.: 19/058,620

(22) Filed: Feb. 20, 2025

Related U.S. Application Data
(60) Provisional application No. 63/555,823, filed on Feb. 20, 2024.

(51) Int. Cl. G06F 21/56; G06F 21/55; G06F 21/57

(52) U.S. Cl. CPC G06F 21/563; G06F 21/552; G06F 21/577

(57) ABSTRACT

A cloud security platform configured to protect a cloud environment is described. The cloud security platform features a cloud analysis logic and cloud security system. The cloud analysis logic is configured to (i) identify one or more security threats associated with a code submission for evaluation and (ii) generate a message including information associated with the one or more security threats. The cloud security system is configured to determine a difference between the one or more security threats associated with the code submission and at least one security threat associated with a prior code submission or production code that pertains, at least in part, to the code submission. The difference causes the cloud security system to refrain from release of code included in the code submission as production code.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### RELATED APPLICATION

This application claims priority under 35 USC § 119 to U.S. Provisional Patent Application No. 63/555,823, entitled “Cyber Security” filed on Feb. 20, 2024, where content of this application is incorporated by reference herein.

### FIELD

Embodiments of the disclosure relate to cyber security, and in particular, code analysis logic that identifies newly created security vulnerabilities in code, such as infrastructure as code (IaC), for analysis prior to release to protect network infrastructure and a code security module for expanded cloud platform protection.

### BACKGROUND

Infrastructure as Code (IaC) is a practice where infrastructure is provisioned and managed using code and automation, rather than through manual processes. This practice allows developers and operations (DevOps) teams to define and manage information technology (IT) infrastructure using configuration files, where the configuration files can be versioned and treated like application code. Using IaC open-source tools, such as Terraform for example, DevOps teams can specify the desired state of the infrastructure, and the IaC tool ensures that the infrastructure matches this state. The benefits of IaC are numerous, including increased efficiency in infrastructure management, which involves overseeing and maintaining components of an organization's infrastructure inclusive of hardware, software, networking components, notably logical components with such functionality.

Herein, IaC can be integrated into a Continuous Integration and Continuous Deployment (CI/CD) pipeline, which includes a set of automated processes that allow DevOps teams to build, evaluate, and deploy code changes, such as IaC changes, more efficiently and reliably. More specifically, the CI/CD pipeline is adapted to perform continuous integration by integrating code changes frequently into a shared repository, where automated builds and tests are run to detect issues. Also, the CI/CD pipeline is adapted to perform continuous deployment by automatically deploying code changes to production after passing all tests, ensuring that new features and fixes are delivered to users quickly and consistently.

Currently, the CI/CD pipeline is adapted to test received code before production (release); however, such testing does not evaluate the received code for newly introduced security threats, namely vulnerabilities and misconfigurations detected for the received code compared to existing vulnerabilities and misconfigurations associated with code that is currently in production (hereinafter, “production code”). Without such testing, newly introduced security vulnerabilities created by the received code are much more difficult to uncover and may go unnoticed, leaving the infrastructure associated with the received code potentially more susceptible to attack or accidental data leakage. This can result in significant financial and legal consequences.

Also, given that security threat comparisons is not being utilized by conventional technologies, enterprises are currently handling security threats caused by newly released code in a reactive manner, namely fixing code after production which is both time-consuming and costly. Such post-production code fixes often require emergency patches and hotfixes, which can disrupt code development workflow and delay other projects. Also, as the volume of production code (codebase) associated with an organization's infrastructure grows, the insertion of faulty code may cause the codebase to be more difficult to maintain and diminishes the lifecycle of the codebase.

Hence, security vulnerabilities within an organization's infrastructure are currently uncovered in a reactive condition when, in fact, these vulnerabilities in comparison with existing vulnerabilities should be identified and addressed in an initiative-taking (proactive) manner prior to release. Also, there is no aggregation of security services for verification of cloud infrastructure vulnerabilities to confirm findings of existing security threats, which may be useful in predicting future security threats.

### SUMMARY

Methods, systems, and apparatus are disclosed for an Artificial Intelligence based (AI-based) enterprise security platform. In general, the AI-based enterprise security platform features a cloud security system communicatively coupled to a cyber security appliance. The cloud security system provides a security platform that may be deployed as part of an on-premises (hereinafter, “on-prem”) network to detect and mitigate security threats, such as vulnerabilities and/or misconfigurations, in code directed to cloud infrastructure changes before deployment. This may be accomplished, in part, by (i) code analysis logic (e.g., infrastructure as code scanner), which determines security threats associated with pre-production (evaluated) code and (ii) a cloud security system that integrates data from cloud providers, determines whether the evaluated code introduces additional security threats, and prompts generation of visualizations of the proposed changes and their security implications. These operations are automated to identify problematic evaluated code and suggest modification of the same before production (deployment). The system aims to shift security threat detection earlier in the development process and enable more proactive cloud security management.

In general, one embodiment of the disclosure is directed to the cyber security system that is adapted to utilize different methods of utilizing cloud cyber security for Infrastructure as Code (IaC) code analytics, including visualizing the architectures that will be modified by changes, highlighting future misconfigurations created by the proposed implementation, and rejecting changes which introduce vulnerabilities. While operations associated with IaC code provided as code submissions into a Continuous Integration and Continuous Deployment (CI/CD) pipeline for testing are described, it is contemplated that the below described operations can extend to code associated with testing in another type of pipeline, not only IaC testing in CI/CD pipelines.

The code analysis logic may be designed to perform IaC scanning. Herein the code analysis logic would determine any security threats, namely any vulnerabilities, misconfigurations, or problematic dependencies or the like, associated with IaC code (IaC files) committed to a Git repository. The code analysis logic is configured to send metadata about the changes and found security threats to the cloud security system. There are two analytic data flows.

First, the cloud security system may be adapted to use this data to gather basic context about how this will affect cloud infrastructure currently running in an associated customer cloud environment and make an intelligent decision about whether or not to allow this action to continue. The cloud security system is further configured to respond whether the pipeline will pass or fail CI/CD pipeline evaluations, and some information as to why the decision that was made was made to create a report.

Secondly, the metadata which includes the commit and user may be used to create a timeline of IaC activity and how that has affected the customer cloud environment. The metadata may trigger a job to create or modify illustrated cloud assets (e.g., cloud components, cloud architectures, etc.) as to how the customer cloud environment would have looked after the evaluated code is placed into production. This illustration may be adapted to highlight newly introduced security threats or security threats that would be mitigated upon the evaluated code transitioning to production. A detailed report will be generated on the change.

Although this focuses on IaC code analysis, similar operations may be conducted for image scanning, code scanning, code quality and any other “shift left” CI/CD code. Also, the cloud security system may be adapted to perform drift detection via looking at what is in production versus what is expected for code discrepancies and do CI/CD monitoring.

Additionally, the cloud security system can use expanded Amazon Web Services (AWS) capabilities. Also, the cloud security system can protect cloud platforms that helps organizations build, deploy, and manage applications and services, such as Microsoft® Azure®. Also, the cloud security system can protect cloud Kubernetes implementations.

These and other features of the design provided herein can be better understood with reference to the drawings, description, and claims, all of which form the disclosure of this patent application.

### BRIEF DESCRIPTION OF THE DRAWINGS

Embodiments of the invention are illustrated by way of example and not by way of limitation in the figures of the accompanying drawings, in which like references indicate similar items and in which:

FIG. 1A illustrates a block diagram of a first embodiment of code analysis logic deployed as part of a customer on-premises (“on-prem”) network to (a) conduct analytics on code submissions from the DevOps team prior to release, (b) autonomously cause CI/CD pipeline failure upon detection of a first set of vulnerabilities that could be introduced by the code submission upon release, and/or (c) operate with a cloud security system to generate information for assessing whether a second set of vulnerabilities that could be introduced by the code submission warrant withholding the code from release.

FIG. 1B illustrates a block diagram of a second embodiment of code analysis logic of FIG. 1A deployed as part of a cloud service.

FIG. 2 illustrates a block diagram of the general interactions between the code analysis logic of FIGS. 1A-1B operating with the cloud security system, output systems, and a cyber security appliance.

FIG. 3 illustrates a block diagram of the services provided by the code analysis logic, the cloud security system, and the cyber security appliance in conducting analytics on infrastructure as code (IaC) files prior to release of the IaC configuration in which infrastructure changes defined in the IaC code are provisioned and managed according to the approved IaC configuration.

FIG. 4 illustrates a block diagram of an embodiment of the cyber security appliance of FIG. 3.

FIG. 5A illustrates an exemplary embodiment of a first display layout representing a cloud security interface generated by the GUI control unit of the cyber security appliance of FIG. 4.

FIG. 5B illustrates an exemplary embodiment of the main workspace featuring display elements representing the cloud components affected by the code in development as determined by the code analysis logic of FIG. 3.

FIG. 6 illustrates a flowchart of the operations of the code analysis logic of FIG. 1A-FIG. 3.

FIG. 7 illustrates a block diagram of a first embodiment of the cloud security system of FIG. 1A adapted with the cloud security module leveraging operability of cloud security services associated with different cloud network providers to enhance cloud security.

While the design is subject to various modifications, equivalents, and alternative forms, specific embodiments thereof have been shown by way of example in the drawings and will now be described in detail. It should be understood that the design is not limited to the particular embodiments disclosed, but—on the contrary—the intention is to cover all modifications, equivalents, and alternative forms using the specific embodiments.

### DESCRIPTION

In the following description, numerous specific details are set forth, such as examples of specific data signals, named components, specific interconnectivity, etc., in order to provide a thorough understanding of the present design. It will be apparent, however, to one of ordinary skill in the art that one or more embodiments of the disclosure can be practiced without these specific details. In other instances, well-known components or methods have not been described in detail but rather in a block diagram in order to avoid unnecessarily obscuring the present design. Further, specific numeric references, such as a first component for example, have been made. However, the specific numeric reference should not be interpreted as a literal sequential order but rather interpreted that the first component may be different from a second component.

As set forth herein, the specific details are merely exemplary and for illustrative purposes. Hence, the features implemented in one embodiment may be implemented in another embodiment where logically possible. The specific details can be varied from and still be contemplated to be within the spirit and scope of the present system or component configuration.

### I. Terminology

In the following description, certain terminology is used to describe various features of the invention. For example, the terms “component,” “module” and “logic” are structures that can be implemented with electronic circuits, software stored in a memory executed by one or more processors, and/or a combination of both. For instance, the component (or module or logic) may be representative of hardware, firmware or software that is configured to perform one or more functions. As hardware, a component (or module or logic) may include physical circuitry having data processing or storage functionality. Examples of such circuitry may include, but are not limited or restricted to a hardware processor (e.g., microprocessor with one or more processor cores, a digital signal processor, a graphics processing unit (GPU), a programmable gate array, a microcontroller, an application specific integrated circuit “ASIC,” etc.), a semiconductor memory, or digital or analog hardware.

Alternatively, the component (or module or logic) may be software that includes code being one or more instructions, commands, files, or another data structures that, when compiled and/or processed (e.g., executed), perform a particular operation or a series of operations. Examples of software may include an application, a process, an instance, an Application Programming Interface (API), a routine, a subroutine, a plug-in, a function, an applet, a servlet, code, a script, a shared library/dynamic link library (dll), infrastructure as code (IaC) code that may consist of configuration files, logical circuitry (e.g., logical functionality of the physical circuitry descried above), or one or more instructions. This software may be stored in any type of a suitable non-transitory storage medium, or transitory storage medium (e.g., electrical, optical, acoustical, or other form of propagated signals such as carrier waves, infrared signals, or digital signals). Examples of non-transitory storage medium may include, but are not limited or restricted to a programmable circuit; non-persistent storage such as volatile memory (e.g., any type of random-access memory “RAM”); or persistent storage such as non-volatile memory (e.g., read-only memory “ROM,” power-backed RAM, flash memory, phase-change memory, etc.), a solid-state drive, hard disk drive, an optical disc drive, or a portable memory device. As firmware, the component (or module or logic) may be stored in persistent storage.

In general, the term “infrastructure” generally relates to any logical or physical component that performs a specific task or function, such as managing security of a logical or physical network, data storage, virtual processing, or the like. Hence, cloud infrastructure relates to one or more logical components that perform a specific task or function within a cloud network. Examples of infrastructure may include, but are not limited or restricted to ephemeral, cloud-based components or services such as compute engines (e.g., AWS™ EC2, Azure® Azure® virtual machines, Google® compute engine, etc.), logical data stores (e.g., AWS™ S3, Azure® blob storage, etc.), policies, roles, users, certificates, virtual machines, network-based assets such as virtual private clouds (VPCs) or subnets, edges (communication paths between two logical components), or the like.

The term “content” generally relates to a collection of information, whether in transit (e.g., over a network) or at rest (e.g., stored), often having a logical structure or organization that enables it to be classified for cloud architecture formation and cyber-threat detection and prevention.

Herein, the term “element” relates to a visual representation of content. For example, in some cases, the term “display element” relates to a broader visual representation of a segment of infrastructure (e.g., web page, window, etc.), and the term “graphical element” relates to a more specific visual representation of infrastructure such as one or more objects. The graphical element may be interactive, where the graphical element may be a node within the visualization or a graphical filtering element that, upon selection, cause the rendering of additional (display or graphical) elements.

The term “computing device” should be generally construed as electronics with data processing capability and/or a capability of connecting to any type of network, such as a public network (e.g., Internet), a private network (e.g., a wireless data telecommunication network, a local area network “LAN,” etc.), or a combination of networks. Examples of a computing may include, but are not limited or restricted to, the following: a server, a mainframe, a firewall, a router; or an endpoint device (e.g., a laptop, a smartphone, a tablet, a desktop computer, a netbook, gaming console, a wearable, etc.), or the like. The term “computing device(s)” denotes one or more computing devices.

The term “interconnect” may be construed as a physical or logical communication path between two or more components or between different components. For instance, a physical communication path may include wired or wireless transmission mediums. Examples of wired transmission mediums and wireless transmission mediums may include electrical wiring, optical fiber, cable, bus trace, a radio unit that supports radio frequency (RF) signaling, or any other wired/wireless signal transfer mechanism. A logical communication path may include any mechanism that allows for the exchange of content between different components such as function calls or other message delivery techniques.

In general, a “cloud Identity” is a resource (or cloud asset) in a cloud environment and is defined by the cloud network provider such as Amazon Web Services®, Microsoft® Azure®, Google Cloud Platform®, or the like. The cloud identity is accessible to cloud security systems.

The term “message” generally refers to signaling (wired or wireless) as either information placed in a prescribed format and transmitted in accordance with a suitable delivery techniques such as a suitable delivery protocol or information made accessible through a logical data structure such as an API. Examples of the delivery protocol include, but are not limited or restricted to HTTP (Hypertext Transfer Protocol); HTTPS (HTTP Secure); Simple Mail Transfer Protocol (SMTP); File Transfer Protocol (FTP); iMESSAGE; Instant Message Access Protocol (IMAP); or the like. Hence, each message may be in the form of one or more packets, frames, or any other series of bits having the prescribed, structured format. The term “computerized” generally represents that any corresponding operations are conducted by hardware in combination with software or firmware.

The character set “(s)” denotes one or more items. For example, the term “network(s)” denotes one or more networks. The term “components(s)” denotes one or more components. The term “cloud modules(s)” denotes one or more cloud modules, and the like.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of components, logic, functions, steps, or acts are in some way inherently mutually exclusive.

### II. General Architecture

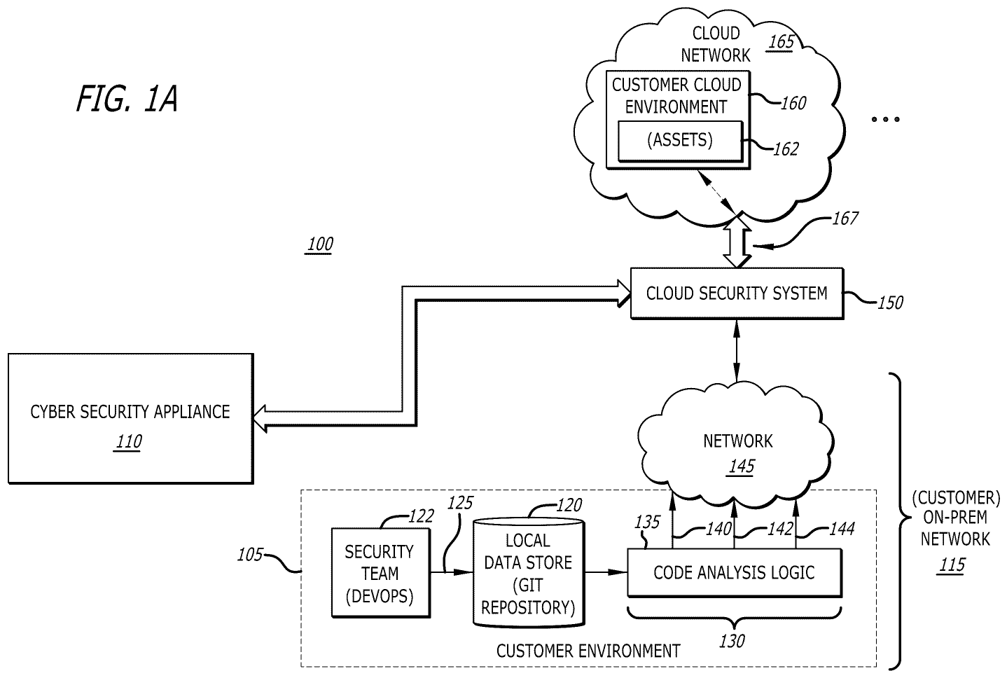

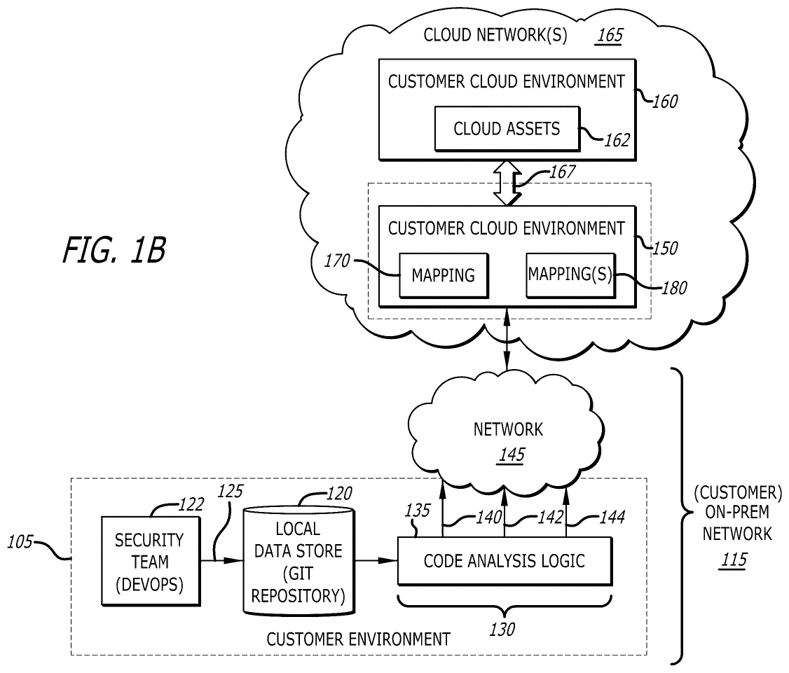

Referring to FIG. 1A, a block diagram of a first embodiment of a security platform 100 for an enterprise (hereinafter, “enterprise security platform”) is shown. Herein, the enterprise security platform 100 features a customer environment 105, a cyber security appliance 110, and a cloud-based security system 150 (hereinafter, “cloud security system”) communicatively coupled to the client environment 105 and the cloud security appliance 110. Deployed as part of a customer on-premises (“on-prem”) network 115, the customer environment 105 features a local data store 120 for temporary storage of code in development (hereinafter, “code submission”) that is accessible by a Continuous Integration and Continuous Deployment (CI/CD) pipeline 130. The CI/CD pipeline 130 conducts vulnerability scanning, and resource identification as described below.

According to one embodiment of the disclosure, the CI/CD pipeline 130 features code analysis logic 135, which is configured to conduct analytics on the code submission 125, such as code developed and provided from a security team 122 (e.g., DevOps team). The code submission 125 is temporarily stored in the local data store 120 and subsequently directed to the CI/CD pipeline 130 prior to release. Additionally, the code analysis logic 135 is configured to determine (i) a code identity 140 for the code submission 125, (ii) security threat(s) 142 (e.g., one or more vulnerabilities and/or misconfigurations) that would be introduced by the code submission 125 upon release, and (iii) additional metadata 144 (e.g., predicted cloud environment will be deployed, predicted names as to cloud identifies associated with the code submission 125, etc.).

It is contemplated that the code analysis logic 135 may be further configured to autonomously cause failure of the CI/CD pipeline 130 upon detecting that the determined security threat(s) 142 arise to at least a prescribed threat risk to warrant failure of the CI/CD pipeline 130. This may involve a determination whether the determined security threat(s) pertain to a set of security threats that pose a significant danger to the operability of the customer cloud environment 160 being protected by the cloud security system 150. Otherwise, the code analysis logic 135 provides information associated with the security threat(s) 142, with the code identity 140 and additional metadata 144, to the cloud security system 150. The cloud security system 150 is configured to determine whether the security threat(s) 142, which could be introduced by the code submission 125, warrant a halting or delay in the release of the code submission 125. The cloud security system 150 is further configured to generate visualizations to what cloud assets within the customer cloud environment 160 are affected by the security threats(s) 142.

As shown in FIG. 1A, the cloud security system 150 is configured to autonomously interact with the customer cloud environment 160 maintained within the cloud network 165 via interconnect(s) 167. Herein, the cloud security system 150 is configured to identify cloud assets 162 within the customer cloud environment 160 and access metadata associated with the cloud assets 162. The cloud assets 162 may include cloud-based components, services, and/or access controls (e.g., roles, policies including permissions, profiles, etc.) associated with the customer cloud environment 160, which are maintained within the cloud network 165 operating as a part of a public cloud network. Alternatively, the cloud network 165 may operate as one or more private cloud networks accessible to one or more users of the enterprise.

As further shown in FIG. 1A, the on-prem network 115 features a local network 145 that enables communications between a number of computing devices such as one or more computing devices pertaining to the DevOps team 122 provided to the local data store 120 such as a Git repository. A “Git repository” is a distributed version control system (i.e., type of software tool) that is used to store code in software development to track its changes and allow developers to work collaboratively to manage code changes on projects that affect the codebase. The code differences may be determined by the Git repository 120. One type of code submission 125, namely Infrastructure as Code (IaC) code described below as an illustrative example, may be submitted by the DevOps team 122 into the Git repository 120. The CI/CD pipeline 130 is configured to scan and analyze the IaC code 125 from the Git repository 120. This analysis is conducted prior to the IaC code 125 being provided to the cloud security system 150 and prior to release of code to production.

Upon receipt of the IaC code 125 into the CI/CD pipeline 130, the code analysis logic 135 is configured to determine whether or not the code submission 125 poses security threat(s) (e.g., vulnerabilities and/or misconfigurations) to the customer cloud environment 160. In particular, the code analysis logic 135 may be configured to perform static analyses and/or dynamic analyses on the code submission 125. For example, the code analysis logic 135 may conduct a static analysis to determine whether the code originator (e.g., certain person on the DevOps team 122) is permitted to submit the IaC code 125 to the Git repository 120. As another example, the code analysis logic 135 may conduct a dynamic analysis of the IaC code 125 to simulate operability of the code to identify vulnerabilities and/or misconfigurations introduced by the IaC code 125 prior to production.

In summary, the code analysis logic 135 may be configured to conduct a scan of the IaC code 125 to identify potential security threats 142 (e.g., vulnerabilities and/or misconfigurations) associated with the IaC code 125 and generate additional metadata 144 pertaining to context associated with the IaC code 125 (e.g., a type/provider of cloud network to which the IaC code 125 pertains, etc.). Also, the code analysis logic 135 is configured to provide the code identity 140 associated with the IaC code 125, where the code identity 140 may correspond to a block of code that defines a cloud identity for a given cloud network provider. For example, if the IaC code 125 is directed to spinning up an EC2 instance for Amazon Web Services (AWS), the code identity defines the settings for the EC2 instance in a code block called ‘ec2 instance <setting config>. At the cloud security system 150, a mapping can be established between the code identity and the cloud identity associated with the EC2 instance.

Herein, in communication with the cloud network 165 as well as other cloud networks for access to code identities associated with these cloud networks, the cloud security system 150 is configured to map the code identity 140 to a cloud identity using the metadata 144 provided by the code analysis logic 135. The cloud security system 150 is further configured to compare these potential security threats 142 with known security threats associated with current production code and/or prior scans of code submissions performed by the code analysis logic 135. This comparison is conducted to uncover differences and potentially additional vulnerabilities and/or misconfigurations introduced by the IaC code 125. The determination of security threat differences between the code submission 125 and the production code is invaluable to assist an automated process or a security administrator in deciding whether the code submission 125 may be released to production or needs to be modified to mitigate or eliminate the newly introduced security threats.

Referring still to FIG. 1A, the cyber security appliance 110 may be a component residing outside the on-prem network 115 as shown or may be implemented as part of any or all of the computing devices located within the on-prem network 115. As this illustrative example, the cyber security appliance 110 may be configured to detect security threats pertaining to the code submission 125 based on analytics utilizing Artificial Intelligence (AI) such as AI models directed to the pattern of life (e.g., normal or expected behaviors and/or activities) of an originator of the code submission 125. As such, the cyber security appliance 110 may include one or more processors arranged to run the steps of the process described herein, memory storage components required to store information related to the running of the process, as well as network interfaces for collecting and acquiring information from the cloud security system 150. Alternatively, the cyber security appliance 110 may constitute a service or instance operating within the on-prem network 115 and/or the cloud network 165.

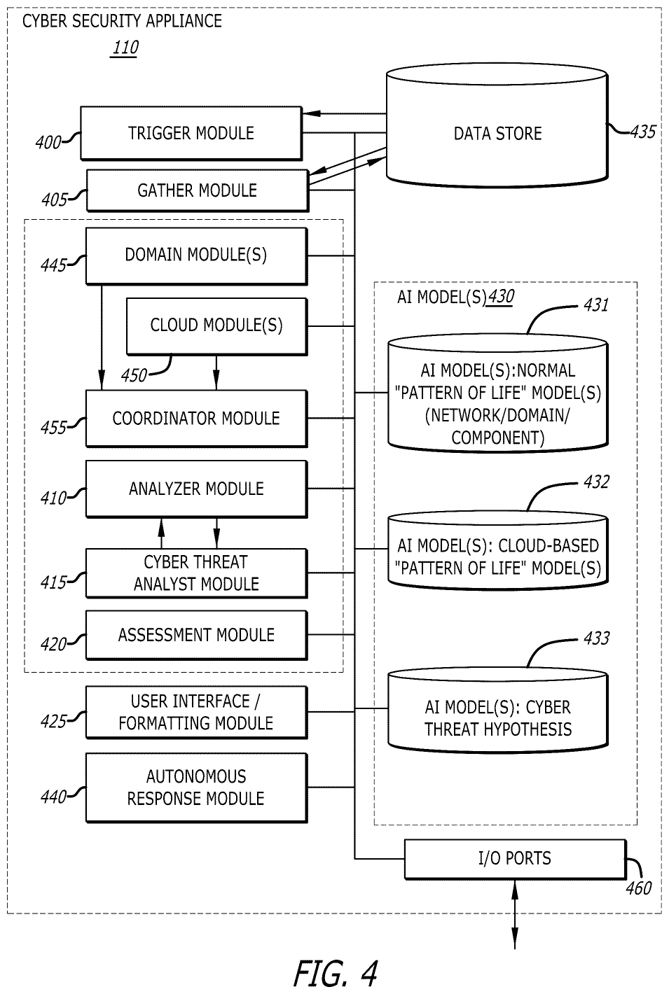

As described in more detail with reference to FIG. 4, the cyber security appliance 110 is configured to build and maintain dynamic, ever-changing models of the “normal behavior” of each user and computing device associated with a customer (e.g., a corporation, organization, governmental entity, partnership, group of persons, etc.) as well as multiple, related cloud assets and/or architectures utilized by a customer deploying the enterprise security platform 100. This approach may be based on Bayesian mathematics, and monitors all interactions, events, and communications within both the system (e.g., which computer is talking to which, files are being created, networks are being accessed or the like) and the customer environment 105 within the on-prem network 115.

The AI modeling of the normal pattern of life for an entity (e.g., person, asset, etc.) in a network under analysis is used as a moving benchmark, allowing the cyber security appliance 110 to spot behavior on with the enterprise security platform 100, including the customer environment 105 and/or the customer cloud environment 160 as monitored by the cloud security system 150, that seems to fall outside of the normal pattern of life and flags this behavior as anomalous, requiring further investigation and/or autonomous action. These operations are based on activity by the user as the cyber security appliance 110 takes into account the activities as described above as well as the risks associated with the customer environments 105, which are provided by the cloud security system 150 and based, at least in part, on misconfigurations, vulnerabilities, the presence of sensitive data within publicly accessible cloud assets, or the like.

Referring now to FIG. 1B, a block diagram of a second embodiment of the cloud security system 150 deployed as a service within the customer cloud environment 160 of the cloud network 165 is shown. Herein, the cloud security system 150 is configured to communicate with the code analysis logic 135. Differing from FIG. 1A, as shown in FIG. 1B, the code analysis logic 135 is deployed within the cloud network 165 or within the cloud security system 150 that may be deployed, partially or entirely, within the cloud network 165. Hence, external from the customer environment 105, the code analysis logic 135 may be adapted to interact as part of the CI/CD pipeline 130 to access the code submission 125 within the Git repository 120 and collect information associated with the security threats pertaining to the code submission 125. Additionally, besides identifying the security threats associated with the code submission 125 (e.g., IaC, Python, C++, JavaScript, etc.), the code analysis logic 135 is further configured to produce the 144 associated with proposed resources (e.g., cloud components created or modified by the code submission 125 such as a virtual machine, cloud data store, etc.) or infrastructure (e.g., multiple cloud components operating as intended) pertaining to the code submission 125.

As in FIG. 1A, the cloud security system 150 is configured to identify the resource(s) and/or infrastructure to be effected by the code submission 125 and generates a mapping 170 representing the code identity, the determined security threats associated with the code submission 125, and/or a cloud identity (i.e., an identifier used to control access to various cloud resources including cloud infrastructure components such as virtual machines and data stores). The mapping 170 may be stored in a local data store (not shown) accessible to the cloud security system 150 for use in comparison with mapping(s) 180 associated with prior code submission or production code that may be overwritten, in whole or in part, by the code submission 125. This comparison is conducted to determine what additional security threats (if any) would be introduced or removed by the code submission 125 over the production code and what security threats (if any) would be eliminated. Such information provides the enterprise with better visibility of security threats within the customer cloud environment 160 in terms of infrastructure and the particular code running with respect to that infrastructure.

As an illustrative example, with respect to both deployment embodiments illustrated in FIGS. 1A-1B, the DevOps team 122 may be tasked to perform changes to an Application Programming Interface (API) infrastructure and releases code that accidentally allows for network traffic to be routed into the customer environment 105 via a public source (e.g., via the Internet). As a result, an attacker may have direct access to confidential information within the customer environment 105, where such access was never meant to be provided.

In contrast, in accordance with the proposed embodiments, a cloud service (code analysis logic 135) is configured to analyze the code submission 125 for security threats, such as vulnerabilities and/or misconfigurations, and upon determination of this security threat (e.g., errand Internet connectivity), two actions may occur. First, the CI/CD pipeline 130 could fail in response to detection of a certain type of security threat in the testing sequence that exceeds a prescribed threat risk, such as a critical security misconfiguration or vulnerability which may include inadvertently providing public access to the customer environment 105 and/or the customer cloud environment 160. Second, where the security threat is not considered to be a critical, the code identity 140, information associated with the security threat(s) 142, and/or metadata 144 associated with the detected security threat(s) may be provided to the cloud security system 150 while the CI/CD pipeline 130 remains active.

As a result, the cloud security system 150 is configured to determine differences between the security threat(s) (vulnerability and/or misconfiguration) introduced by the code submission 125 and security threat(s) associated with prior code submissions or production code that pertains, at least in part, to the code submission 125. This allows the cloud security system 150 to use updated cloud identities (and any provisional/new cloud identities that will be created when the code associated with the code submission 125 is deployed, to create a visualisation (architecture diagram) of the vulnerability and/or misconfiguration changes and how such changes effect the cloud components forming the customer cloud environment 160. This visualization operates as a notification to security administrators as to the potential vulnerability and/or misconfiguration. This may include a notification as an e-mail or text message outlining the findings or a notification represented by a visualization outlining the security threat uncovered by the code analysis logic 135.

According to one embodiment of the disclosure, the visualization may be a graphical depiction of infrastructure associated with the customer cloud environment 160 associated with security threat(s) 142, perhaps highlighting the different security threats introduced or eliminated by the code submission 125. This visualization avoids the code submission 125 from being accidentally placed into production based on the potential security threat being overlooked by a security administrator.

### III. Code Analysis Logic & Cloud Security System Operability

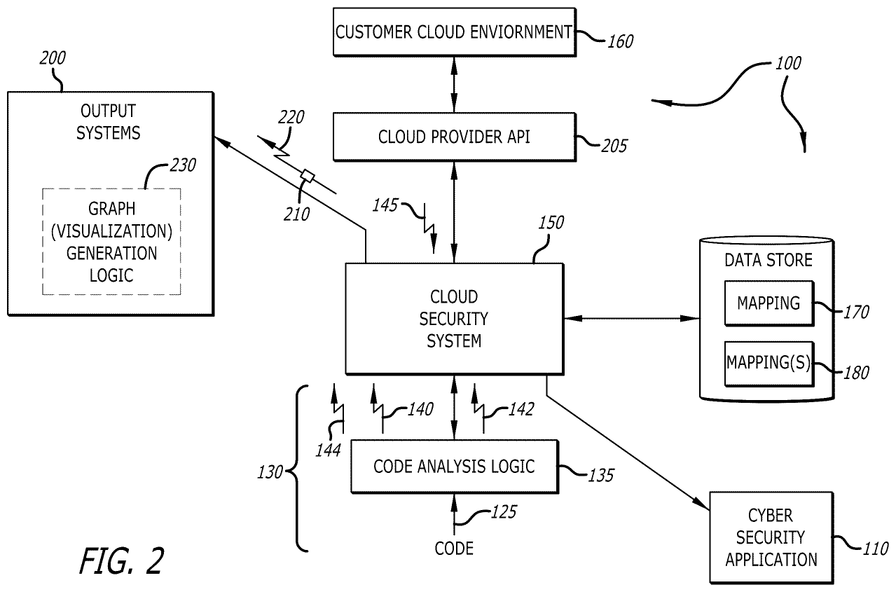

Referring to FIG. 2, a block diagram of the general interactions between the code analysis logic 135 and the cloud security system 150, along with interactions with output systems 200 and the cyber security appliance 110 is shown. Herein, as described above and illustrated in FIG. 1A, the code analysis logic 135 is configured to conduct analytics on the code submission 125 provided to the CI/CD pipeline 130 prior to production. The code analysis logic 135 analyzes the code submission 125 to determine whether the code submission 125 introduces new security threats, removes any known security threats present in corresponding production code, and/or retains security threats that are known to be present in the corresponding production code.

More specifically, the code analysis logic 135 may be configured to conduct analytics on the code submission 125 provided to the CI/CD pipeline 130 by at least analyzing the code submission 125 for security threats 142 including code dependencies (e.g., certain code segments made inoperable due to necessary data from a programming library, script, etc. being unavailable), code misconfigurations (e.g., code changes in which system or application settings are incorrectly configured or essential configurations are missing), and/or code vulnerabilities (e.g., code changes that cause weakness in the infrastructure that can be exploited by attackers, thereby potentially compromising security of the customer environment 105 and/or customer cloud environment 160). The code submission 125 is assigned the code identity 140, which is used to identify a block of code that defines a type of cloud identity for a given cloud network provider, thereby identifying a type of cloud asset (resource) that pertains to the code submission 125. At least the code identity 140 and security threats 142 are provided to the cloud security system 150.

With access to the customer cloud environment 160 via an API 205, the cloud security system 150 is configured to map the uncovered security threat(s) 142 along with the code identity 140 to a cloud identity, namely information representative of a set of technologies, protocols, and practices that enable managing and controlling user identities and access to one or more cloud components in the customer cloud environment 160. This mapping 170, inclusive of at least the cloud identity and security threat(s) 142 associated with the code submission 125, undergoes a comparison with one or more mappings 180 associated with corresponding code that is currently in production (cloud identity; known security threats). Differences may be determined to identify additional security threats that may be introduced or eliminated by the code submission 125 and stored as metadata 210. The metadata 210 associated with the security threat difference may be provided to the output systems 200.

As further shown in FIG. 2, the cloud security system 150 is communicatively coupled to the output systems 200 and the cyber security appliance 110. More specifically, after conducting operations on the mappings 170/180 to identify security threat differences offered by the code submission 125, the cloud security system 150 may be configured to provide one or more messages 220 to the output systems 200, where the messages 220 may include the metadata 210 and other data that operate as display message signaling (e.g., SLACK® messages, chat messages over a video-conferencing platform, graphical signaling for rendering cloud architecture representations, etc.), or even a ‘support” or “help” message (e.g., GitLab™ or service-related ticket). These messages 220 may cause graph generation logic 230, deployed within one of the output systems 200, to generate a visualization to be provided to the cyber security appliance 110 for display.

Additionally, or in the alternative, the cloud security system 150 is further be coupled to the cyber security appliance 110 for visualization rendering and to leverage AI modeling, autonomous response to security threats, and other modules in order to identify and tackle potential cyber threats as described in FIG. 4.

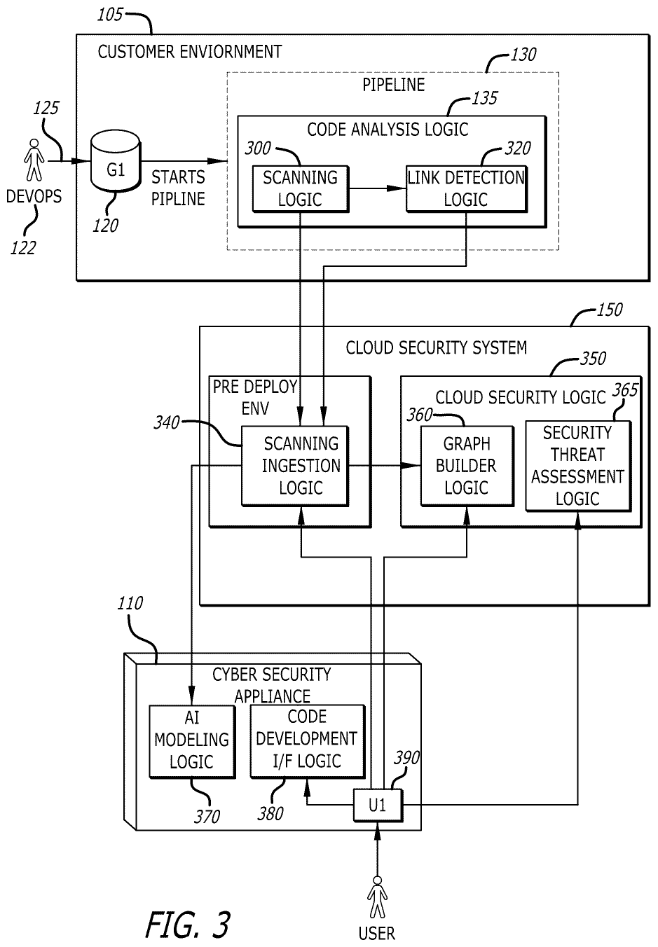

Referring now to FIG. 3, a block diagram of services provided by the enterprise security platform 100 including code analysis logic 135, the cloud security system 150, and the cyber security appliance 110 in conducting analytics on the code submission 125, such as IaC code prior to release, is shown. Herein, the code analysis logic 135 features scanning logic 300 and link detection logic 320. The cloud security system 150 features scanning ingestion logic 340 and cloud security logic 350, and the cyber security appliance 110 features AI modeling logic 370 and code development interface logic 380.

As shown in FIG. 3, upon the DevOps team 122 providing the IaC code 125 to the Git repository 120, which is subsequently provided the CI/CD pipeline 130, the scanning logic 300 of the code analysis logic 135 is adapted to scan the IaC code 125 for misconfigurations and/or vulnerabilities. This scanning may involve analysis of information associated with the IaC code 125, such as the originator of the IaC code 125 to determine whether the IaC code 125 was provided by a developer authorized by the DevOps team 122 to upload and evaluate the IaC code 125 for example.

Additionally, the scanning may involve analysis of the contents of the IaC code 125. The code identity 140 associated with the IaC code 125 may be generated during formation of the IaC code 125.

As an illustrative example, the scanning logic 300 may be adapted to (i) check for code dependencies by at least identifying one or more code segments made inoperable due to changes imposed by the IaC code 125, (ii) check for misconfigurations such as changes in system or application settings are incorrectly configured or essential configurations are missing, and/or (iii) check for code vulnerabilities such as code changes that provide greater chances of exploitation by attackers. These check operations are adapted to identify security threat(s) associated with the IaC code 125.

It is contemplated that these check operations, such as the checking for code vulnerabilities for example, may be conducted by establishing rules directed to operability of the IaC code 125 and determining any rule violations. Where certain rule violations impose significant security threats to the customer environment 105 or the customer cloud environment 160, the scanning logic 300 may be adapted to halt operability of the CI/CD pipeline 130 so that the IaC code 125 will not reach production. The CI/CD pipeline 130 would be reactivated by attending to the failed test process so that the IaC code 125 can pass the testing in the next test cycle. For those rule violations that do not impose significant security threat, the code analysis logic 135 is adapted to gather information associated with the detected rule violations as the security threat(s) 142. This information is passed to the cloud security logic 350 from the code analysis logic 135.

Operating with the scanning logic 300, the link detection logic 320 is configured to determine, based on the code identity, existing or proposed cloud components (resources) affected by the IaC code 125. The link detection logic 320 is further configured to provide contents associated with these determinations as a portion of the metadata 144, which is passed with the code identity 140 to the cloud security system 150.

Referring still to FIG. 3, the scanning ingestion logic 340 of the cloud security system 150 is configured to (i) identify a cloud identity based on the code identity 140 and/or the metadata 144 and (ii) generate the mapping 170, which includes at least information associated with security threat(s) 142 and the cloud identity. In particular, the scanning ingestion logic 340 transforms content of the mapping 170 into storable data and may assign rankings to the content that correlates to the likelihood and/or severity of security threats associated with the IaC code 125 for use by the cloud security system 150 to determine whether the IaC code 125 passes or fails the CI/CD pipeline 130.

The cloud security logic 350 may be adapted with one or more APIs to provide connectivity with different services. For instance, the cloud security logic 350 may include a graph builder logic (e.g., graph builder API) 360 and a security threat assessment logic (e.g., security threat assessment API) 365. The graph builder logic 362 is adapted as a service that allows user access to the output systems 200. The output systems feature logic adapted to (i) generate visualization(s) such as graphical display(s) associated with the customer cloud environment and (ii) identify cloud components exposed to security threats, especially those cloud components associated with new security threats introduced by the IaC code 125. The security threat assessment logic 365 is adapted as a service that analyzes the security threat(s) (e.g., code dependency errors, vulnerabilities misconfigurations, etc.) based on the cloud resources affected and conducts a prioritization to assist the user in identifying the riskiest security threats.

More specifically, according to one embodiment of the disclosure, the scanning ingestion logic 340 is further configured to provide at least a portion of the mapping 170 (e.g., code identity and corresponding cloud identity or identifies) to the graph builder logic 360 within the cloud security logic 350 to assist generation of a visualization of the cloud assets associated with customer cloud environment surrounding the cloud identity to highlight potential new security threat(s) being introduced by the IaC code 125.

The scanning ingestion logic 340 further provides the mapping 170 to security threat assessment logic 365 within the cloud security logic 350. The security threat assessment logic 365 is configured to conduct comparison(s) between the mapping 170 with the mapping(s) 180 associated with prior evaluations of code associated with the cloud identity, such as a mapping associated with current production code associated with component(s) associated with the cloud identity for example, is conducted to identify differences between the potential security threats associated with the IaC code 125 if placed in production and the security threats associated with the production code as identified by the mapping(s) 180.

From this comparison by the scanning ingestion logic 340, the cloud security logic 350 is able to pass or fail the CI/CD pipeline 130 and trigger output systems via the graph builder logic 360 to generate a visualization that illustrates the changes in cloud infrastructure caused by IaC code 125 as well as highlighting potential security threats associated with those changes. For example, the visualization may highlight potential new vulnerabilities being introduced through distinct visual characteristics such as a selected illustrative color, font type and/or size differences, or other changes within the visualization to highlight those vulnerabilities and/or misconfigurations.

Referring still to FIG. 3, the cyber security appliance 110 is adapted with AI modeling logic 370 and code development interface logic 380. The AI modeling logic 370 is configured to receive user/device activity information from the scanning ingestion logic 340 and passes the user activity information to machine learning (ML) logic in order to generate a pattern of life associated with that user or a device used by the user. The pattern of life (POL) constitutes a pattern of normal behavior and activities associated with a user or a device within a network accessed by the user. Based on the PoL, administrators are capable of understanding deviations in behavior or activities that may indicate a potential security threat is in process.

The code development interface logic 380 is configured as a service that provides connectivity to personnel within the enterprise, such as members of the DevOps team 122 who which are pushing proposed IaC code to the Git repository 120. This allows us to prioritize potential code issues based on human risk scoring. For example, IaC code uploaded by a newly employed code developer may pose a higher threat risk than a senior code developer with significant experience in coding and understanding of the customer cloud environment 160. Hence, the AI modeling logic 370 routing of user activity information to the AI model(s) enables the enterprise security platform to better understand profiles of individual users to provide an indication as to whether or not certain code uploads are riskier (from a security threat perspective) than others.

As further shown in FIG. 3, the scanning ingestion logic 340 and cloud security logic 350 are communicatively coupled to graphical user interface (GUI) control unit 390 to allow user access to the output systems 200 for selection of different graphical visualizations and modification of such visualizations.

Referring now to FIG. 4, a block diagram of an exemplary embodiment of the cyber security appliance 110 of FIGS. 1A-1B is shown. The cyber security appliance 110 is configured to protect an enterprise, including but not limited to its customer cloud environment 160, from cyber threats. Various logic and components, such as AI-based models and modules of the cyber security appliance 110, cooperate to protect the customer cloud environment 160 from security threats evidenced by abnormal user or computing device activity that may suggest problems with code submissions that pertain to infrastructure changes within the customer cloud environment. The protections offered by the cyber security appliance 110 are reactive (i.e., response to threats made on current cloud infrastructure) while the protections offered by the code analysis logic 135 and the cloud security system 150 of FIGS. 1A-3 are protection (i.e., directed to detect potential threats caused by changes in cloud infrastructure). The cloud security system 150 assists in training one or more of the AI model(s) to better detect and address security threats caused by misconfigurations and/or vulnerabilities associated with the cloud infrastructure itself.

According to one embodiment of the disclosure, the cyber security appliance 110 may include a trigger module 400, a gatherer module 405, an analyzer module 410, a cyber threat analyst module 415, an assessment module 420, a formatting module 425, one or more AI model(s) 430, a data store 435, an autonomous response module 440, domain module 445, coordinator module 450, and/or a code development interface logic 380. Herein, the AI model(s) 430 are trained with machine learning on i) one or more pattern of life models 431 for entities in the network/domain/components under analysis (i.e. normal pattern-of-life model(s) 431), ii) one or more pattern of life models 432 for a cloud asset or a group of cloud assets, some may be ephemeral components, directed to an aggregate of behaviours associated with these cloud assets (i.e., cloud-based pattern-of-life model(s) 432), and/or iii) one or more cyber threat hypothesis models 433 each adapted to form and investigate one or more cyber threat hypotheses on what are a possible set of cyber threats and their characteristics, symptoms, remediations, etc

The cyber security appliance 110 is configured to protect a network/domain/asset and/or group of cloud assets from a security threat (insider attack, malicious files, malicious emails, accidental vulnerabilities or misconfigurations, etc.). In an embodiment, the cyber security appliance 110 can protect all of the cloud assets in the customer cloud environment(s) being monitored based on activity, for example, on an individual basis from monitoring communications going to and from the computing device on the network and/or cloud assets 162 within the customer cloud environment 160 of FIGS. 1A-1B. For example, via I/O ports 460, the domain module(s) 445 may communicate with network sensors to monitor network traffic to and from the customer cloud environment as well as receive secure communications from software agents embedded in computing devices/containers. The steps below will detail the activities and functions of several of the components in the cyber security appliance 110.

The gatherer module 405 may have a series of one or more process identifier classifiers. A process identifier classifier can identify and track each process, component and/or device under analysis in the network or the customer cloud environment, making communication connections. The data store 435 may be configured to cooperate with the process identifier classifier to collect and maintain historical data of processes and their connections, which is updated over time as the network is in operation. In an example, the process identifier classifier can identify each process running on a given component or device along with its endpoint connections, which are stored in the data store.

The analyzer module 410 is configured to cooperate with cloud-based AI model(s) 432 in the cyber security appliance 110 to confirm a potential security threat against a cloud asset or grouped cloud assets and/or detect cloud asset vulnerability or misconfiguration that constitute a security threat and make the enterprise susceptible to a cyber threat. A cyber threat analyst module 415 is configured to cooperate with the AI model(s) 430, including the cloud-based AI model(s) 432, to conduct a long-term investigation and/or a more in-depth investigation on potential security threats such as cloud asset vulnerabilities and/or misconfigurations. An algorithm in the analyzer module 410 can cooperate with the gatherer module 405 to collect any additional data and metrics to support a possible cyber threat hypothesis.

More specifically, the analyzer module 410 and/or the cyber threat analyst module 415 can utilize the cloud-based AI model(s) 432 to conduct analytics anomalies associated with activities encountered by a cloud asset and/or misconfigurations associated with the cloud asset based on a comparison of normal behaviors to detected behaviors. These anomalies may include, for example, deviations in normal behavior of a cloud asset or a group (two or more) of related cloud assets that may denote a cyber threat or a misconfiguration. The analyzer module 410 and/or the cyber threat analyst module 415 can cooperate with the AI model(s) 430 trained on potential cyber threats in order to assist in examining and factoring these additional data points that have occurred over a given timeframe to see if a correlation exists between 1) a series of two or more anomalies occurring within that time frame and 2) possible known and unknown cyber threats or misconfigurations. The cyber threat analyst module 415 can cooperate with the internal data sources as well as external data sources to collect data in its investigation.

The cyber threat analyst module 415 in essence allows two levels of investigations of potential cyber threat attacks against a cloud asset or a group of cloud assets. In a first level, the analyzer module 410 and AI model(s) 430 can rapidly detect and then autonomously respond to overt and obvious cyber threats. However, thousands to millions of low-level anomalies occur in a cloud asset or a cloud architecture under analysis. For example, advanced persistent threats attempt to avoid detection by making these low-level anomalies in the system over time during their attack before making their final coup de grâce/ultimate mortal blow against the domain or cloud environment being protected. The cyber threat analyst module 415 conducts investigations over time that can detect these advanced persistent cyber threats actively trying to avoid detection by looking at one or more of these low-level anomalies as a part of a chain of linked information.

The cyber threat analyst module 415 is configured to form and investigate hypotheses on what are a possible set of cyber threats and can also cooperate with the analyzer module 410 with its one or more data analysis processes to conduct an investigation on a possible set of cyber threats hypotheses that would include an anomaly of at least one of i) the abnormal behavior, ii) the suspicious activity, and iii) any combination of both, identified through cooperation with, for example, the AI model(s) 430 trained with machine learning on the normal pattern of life of entities (e.g., components, domains, cloud assets, group of cloud assets, etc.) in the system. The cyber threat analyst module 415 may be configured to submit to check and recheck various combinations/a chain of potentially related information under analysis until each of the one or more hypotheses on potential cyber threats are one of 1) refuted, 2) supported, or 3) included in a report that includes details of activities assessed to be relevant activities to the anomaly of interest to the user and that also conveys at least this particular hypothesis was neither supported or refuted; and thus, needs a human to further investigate the anomaly of interest included in the chain of potentially related information.

It is contemplated that a data analysis process or any analytics can be conducted by algorithms/scripts to perform their function discussed herein; and can in various cases use AI classifiers as part of their operation. It is further contemplated that any portions of the cyber security appliance 110 or the cloud security system 150, when implemented as software, can be stored in one or more non-transitory memory storage devices in an executable format to be executed by one or more processors.

The gatherer module 405 may further extract data from the data store 435 at the request of the cyber threat analyst module 415 and/or analyzer module 410 on each possible hypothetical threat that would include the abnormal behavior or suspicious activity and then can assist to filter that collection of data down to relevant points of data to either 1) support or 2) refute each particular hypothesis of what the cyber threat, the suspicious activity and/or abnormal behavior relates to. The gatherer module 405 cooperates with the cyber threat analyst module 415 and/or analyzer module 410 to collect data to support or to refute each of the one or more possible cyber threat hypotheses that could include this abnormal behavior or suspicious activity by cooperating with one or more of the cyber threat hypotheses mechanisms to form and investigate hypotheses on what are a possible set of cyber threats.

As a starting point, for cloud asset analytics, the cyber security appliance 110 can use the trigger module 400 working with the analyzer module 410 and/or the cyber threat analyst module 415 with the cloud-based AI model(s) 432 to identify a cyber threat or misconfiguration associated with post-deployment code based on a comparison between abnormal behavior and/or suspicious activity.

Many other model breaches of the cloud-based AI model(s) 430 trained with machine learning on the normal behavior of the customer cloud environment (e.g., cloud asset, group of cloud assets, architectures, etc.) can send an input into the cyber threat analyst module 415 and/or the trigger module 400 to trigger an investigation to start the formation of one or more hypotheses on what are a possible set of cyber threats that could include the initially identified abnormal identified abnormal behavior and/or suspicious activity. Note, a deeper analysis can look at example factors such as i) how long has the component, such as a cloud asset for example existed or is registered; ii) what kind of certificate is the communication using; etc.

Referring still to FIG. 4, the autonomous response module 440 is configured to take one or more autonomous mitigation actions to mitigate the cyber threat during the cyberattack. The autonomous response module 440 can reference a cloud-based AI model trained to track a normal pattern of life for cloud asset(s) (e.g. single cloud asset or a group of cloud assets) and/or its cloud architecture itself to perform an autonomous act of, for example, restricting a potentially compromised cloud asset(s) or cloud architecture having i) an actual indication of compromise and/or ii) merely adjacent to a known compromised node, to merely take actions that are within that asset's or cloud architecture's normal pattern of life to mitigate the cyber threat.

The chain of the individual alerts, activities, and events that form the pattern including one or more unusual or suspicious activities into a distinct item for cyber threat analysis of that chain of distinct alerts, activities, and/or events. The cyber threat analyst module 415 may reference the one or more machine learning models trained on, in this example, cloud architecture threats to identify similar characteristics from the individual alerts and/or events forming the distinct item made up of the chain of alerts and/or events forming the unusual pattern.

In the next step, the assessment module 420 with the AI classifiers, once armed with the knowledge that malicious activity is likely occurring/is associated with a given process from the analyzer module 410, then cooperates with the autonomous response module 440 to take an autonomous action such as i) deny access in or out of the device or the network ii) shutdown activities involving a detected malicious agent, iii) restrict devices and/or user's to merely operate within their particular normal pattern of life, iv) adjust access roles associated with the cloud architecture and/or certain cloud assets such as remove some user privileges/permissions associated with the compromised cloud account, and/or v) conduct offensive countermeasures to disable operations of a malicious server responsible for the malicious activity, such as a cyber threat or an on-going cyberattack.

The autonomous response module 440, rather than a human taking an action, can be configured to cause one or more rapid autonomous actions in response to be taken to counter the cyber threat, which may include disabling a source of the cyber threat (e.g., malicious server(s)). The disabling of the malicious server may be accomplished by disabling its ability to communicate with targeted systems.

Herein, the cyber security appliance 110 is configured for an architecture-based approach in operation with the cloud security system 150 of FIGS. 1A-1B. The cloud security system 150 may provide the cyber security appliance 110 with API-based access to services or output systems that generate cloud architectural representation of tens or hundreds of cloud assets along with the interconnections between the cloud assets to provide context as to the relevance of unusual activity alerts or misconfigurations. The behaviors associated with related cloud assets within the architectural representation may be evaluated against enhanced “pattern of life” modeling operating as normal behaviors associated with an aggregate of related, ephemeral cloud assets to identify cyber threats and misconfigurations.

Additionally, based on enumerated contextual data and operational data associated with the cloud asset(s) and risk assessment, the cloud security system 150 is adapted to more effectively and timely conduct respond actions, which improves the overall level of the enterprise during operations of production code as well as code in development as described in FIG. 3. Also, the cloud security system 150 is adapted to provide a virtualization that illustrates the components associated with the code in development based on risk (e.g., severity, cost, or the like) and may be configured to organizes the security threats associated with the code in development in accordance with a remediation plan to illustrate a suggested order of review and/or revision of code segments directed to the code in development based on the risk.

### IV. Exemplary Visualizations

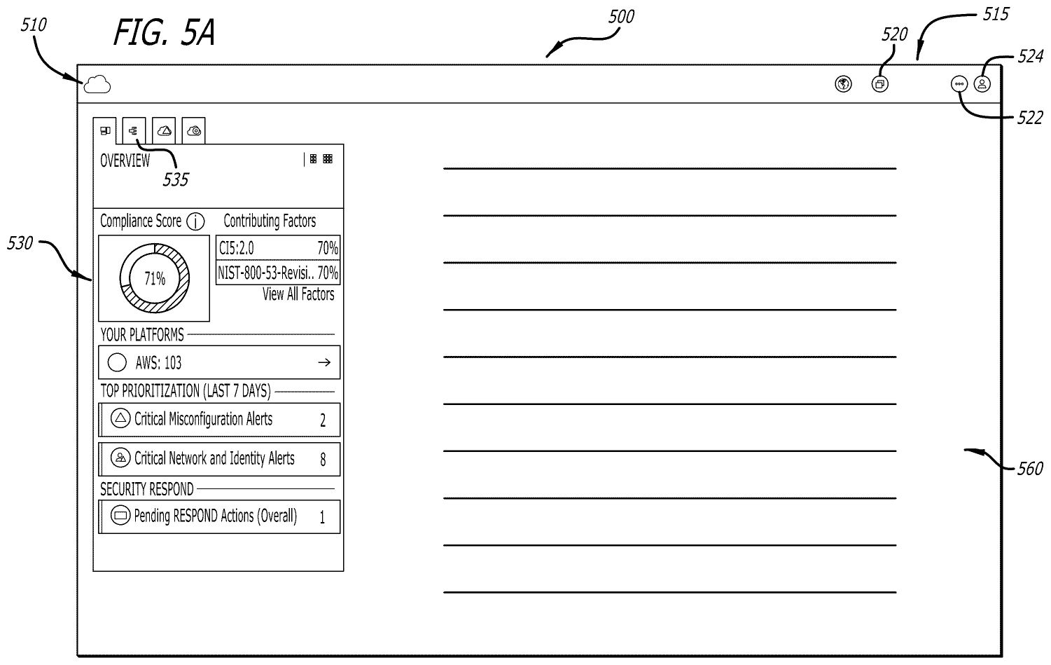

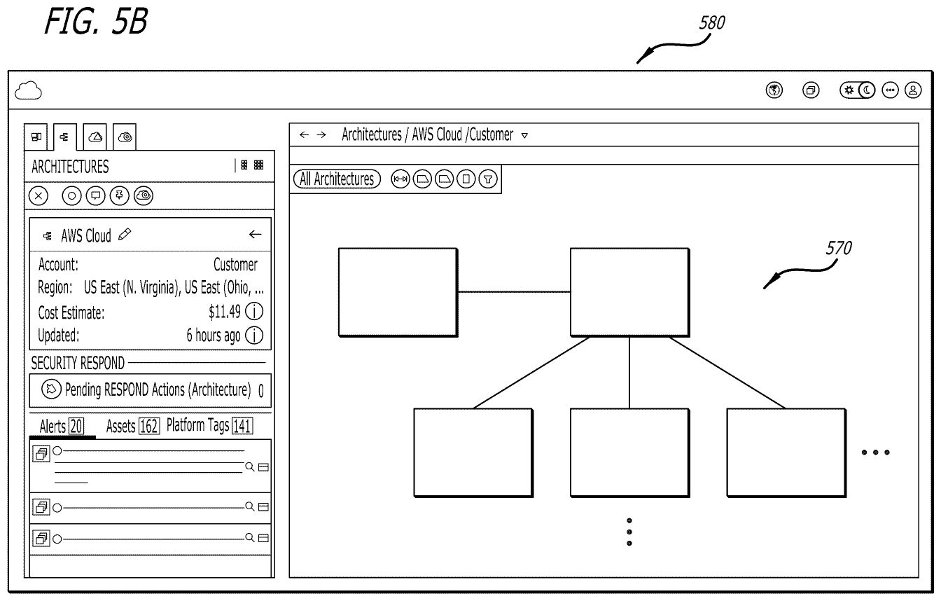

Referring now to FIG. 5A, an exemplary embodiment of a first display layout representing a cloud security interface 500 generated by the GUI control unit 390 of the cyber security appliance 110 is shown. The cloud security interface 500 features a plurality of display elements, including i) a universal toolbar 510, ii) a collapsible, interactive menu 530 that contains filters and key data, and iii) a main workspace 560 where detailed information and graphical elements will appear. According to this embodiment of the disclosure, graphical elements within these display elements, upon selection, may generate additional elements (e.g., window regions, objects, etc.) with more detailed information which can be laid over the main workspace 560.

As shown in FIG. 5A, an illustrative example of the universal toolbar 510 includes a plurality of icons 515. For example, a first icon 520 may be configured to access any minimized display element docked in the tray. A second icon 522 opens a status and administration menu for the cloud security interface 500, which provides access to deployment status, settings, and initial configuration while a third icon 524 enables a log out from the cloud security system platform.

Referring still to FIG. 5A, the interactive menu 530 is positioned laterally from the main workspace 560. The interactive menu 530 allows for selection of four different display element combinations including an architecture display element 535 (see FIG. 5B). In general, according to one embodiment of the disclosure, the architecture display element 535, when selected, is configured to surface graphical (filtering) elements 570 that provide illustrations and information associated with the cloud components affected by the code in development and their interconnectivity, namely interacting cloud assets in the customer cloud environment which form cloud-based infrastructure or systems affected by the code in development. The cloud security system 150 of FIG. 3 automatically constructs these groups of interconnected cloud assets by determining which cloud components are communicatively coupled and representing those cloud components to which vulnerabilities or misconfigurations are directed. For instance, the cloud components may be identified in different colors to identified which components are subject to new security threats and the specific color may identify the risk level of these security threats. The graphical elements 570 may be selectable to allow an administrator to receive additional (more detailed) information regarding the security threat detected.

### V. Exemplary Operational Flow

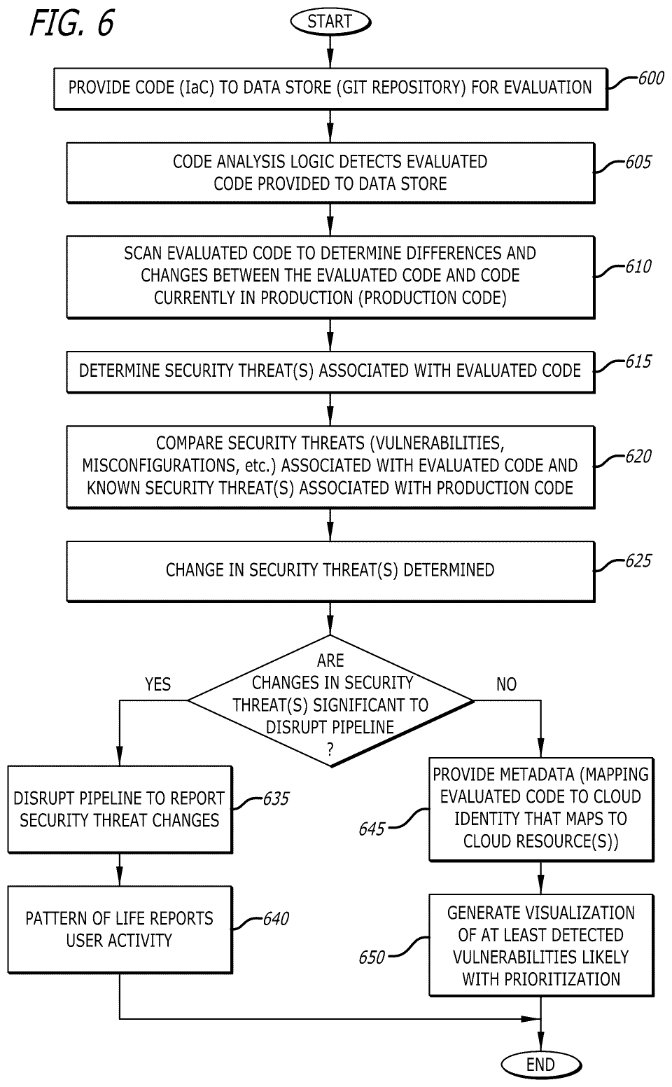

Referring to FIG. 6, a flowchart of the operations of the code analysis logic 135 and cloud security system 150 of FIG. 1A-FIG. 3 is shown. Herein, the code in development (IaC code) is provided to the local datastore such as a Git repository (operation 600). The code analytic logic is configured to detect the IaC code when provided to the Git repository (operation 605). The IaC code is scanned to determine differences between the IaC code and the production code (operation 610). Thereafter, any security threats (vulnerabilities and/or misconfigurations) associated with the IaC code is determined (operation 615).

As an illustrative example, a determination is made as to the vulnerabilities associated with the IaC code. These determined vulnerabilities are compared to known vulnerabilities associated with the production code, and thus, vulnerabilities introduced by the IaC code are determined (operations 620-625).

Thereafter, a first determination is made whether the newly introduced vulnerabilities are significant to disrupt the CI/CD pipeline (operation 630). If so, the CI/CD pipeline is disrupted and the one or more newly introduced vulnerabilities (hereinafter, generally referred to as “vulnerabilities”) are reported (operation 635). The newly introduced vulnerabilities are further provided to AI modeling within the cybersecurity appliance to report and train on activity for pattern of life analysis (operation 640).

In the event that the changes in vulnerabilities are not significant enough to disrupt the CI/CD pipeline, metadata associated with the uncovered vulnerabilities in the form of mappings between the code identity and the uncovered vulnerabilities is provided to the cloud security system (operation 645). In response, the cloud security system operating in combination with other logic modules is configured to generate visualizations of the detected vulnerabilities, including the newly introduced vulnerabilities, with prioritization to identify which vulnerability may warrant prompt by an administrator than other vulnerabilities (operation 650).

### VI. Third-Party Security Integration

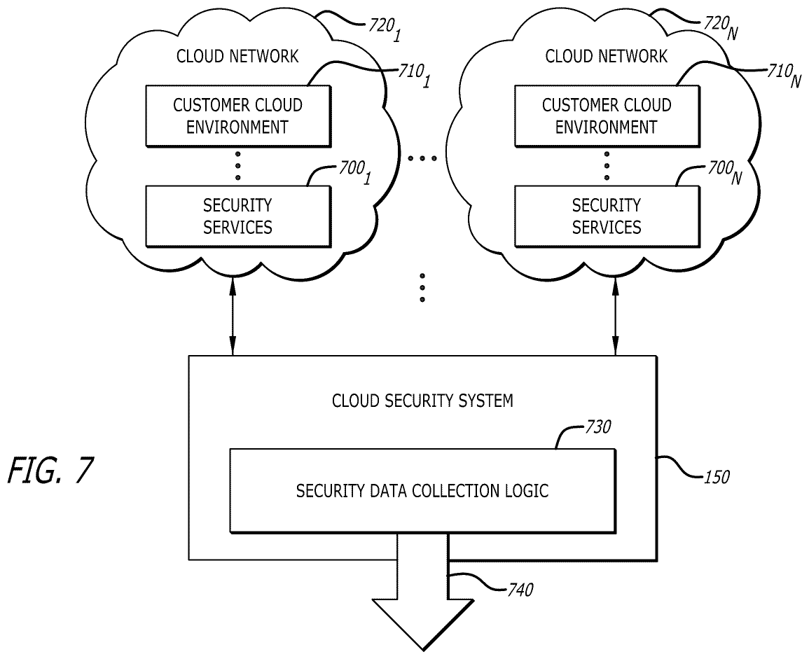

Referring to FIG. 7, a block diagram of an exemplary embodiment of the cloud security system 150 of FIG. 1A is shown, where the cloud security system 150 is adapted to leverage operability of cloud security services 700₁-700_{N} (N≥1) provided by different cloud network providers to enhance the overall security of a customer cloud environment 160. Moreover, the cloud security system 150 provides a centralized resource for multiple sources to provide information associated with potential security threats associated with customer cloud environments in different cloud networks, as these security threats may be different due to infrastructure differences. The security threat information may be useful in providing contextual awareness as to security threats verified by independent third-party security services.

More specifically, the cloud security system 150 may be further configured to include security data collection logic 730, which is adapted to communicate with security services 700₁-700_{N} monitoring corresponding customer cloud environments 710₁-710_{N} operating within their cloud networks 720₁-720_{N} and collect information associated with security threats pertaining to these customer cloud environments 710₁-710_{N}. The security data collection logic 730 aggregates information associated with security threats with its findings in order to provide a report (e.g., visualization through display elements, table, or the like) to show findings 740 made by the enterprise security platform 100 of FIGS. 1A-3 as well as third-party security services. The findings 740 may be illustrated as an aggregate or may be illustrated by separating the findings associated with the enterprise security platform 100 and other cloud-based security services 700₁-700_{N} to provide security teams with sufficient information to make informed decisions about potential infrastructure changes within one or more of the customer cloud environments 710₁-710_{N}.

As an illustrative example, the cloud security system 150 may be adapted to expand Amazon Web Services® (AWS) capabilities. Security threats associated with AWS infrastructure within the customer cloud environment 710₁ may be determined and provided to the cloud security system 150 for centralized evaluation. As a result, the cloud security system 150 is configured to gain perspective as to security threats associated with the AWS cloud infrastructure as determined by the cloud security system 150 as well as the AWS security service 700₁. Correlation between security threat(s) pertaining to AWS infrastructure as determined by AWS security system 700₁ and security threat(s) pertaining to the AWS infrastructure as determined by the cloud security system 150 is useful in confirming proper operability of the cloud security system 150. Also, this correlation enables security teams to make an informed decision as to which cloud assets may be subject to vulnerabilities and/or misconfigurations to warrant modification of that cloud asset.

Herein, the cloud security system 150 is adapted for cloud use expanded AWS capabilities, which may include, but are not limited or restricted to insight reports; Container Scanning; IAM Access Analyzer; Permission analysis recommendations; CVE Scanning; IAWS Integrations: Security Hub/Guard Duty; etc. All customers utilizing the cloud security system 150 will also now benefit from the enhanced identity tracking introduced for cloud security system 150. Rolling out generally to all clients, “pattern of life” analysis will now be performed at the role level for non-IAM actors, resulting in fewer, more consistently tracked cloud identities. Operators can also choose to upgrade to a new, best-practice authentication method for interactions between the enterprise security platform 100 and AWS.

Of course, the cloud security system 150 can also protect customer cloud environments managed by Microsoft® Azure® through anomaly detection; entitlement management; network monitoring expansion; Azure container scanning; bringing detect and respond; and CVE identification. The cloud security system 150 can also protect cloud Kubernetes implementations including Kubernetes Security Posture Management (KSPM) to monitor, assess, and ensure the security and compliance of Kubernetes environments; network monitoring expansion; container scanning; identifying common vulnerabilities and exposures (CVEs); bringing detect and respond capabilities in Kubernetes environments, etc.

Note, an application described herein includes but is not limited to software applications, mobile applications, and programs routines, objects, widgets, plug-ins that are part of an operating system application. Some portions of this description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, Java, HTTP, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A module may be implemented in hardware electronic components, software components, and a combination of both. A software engine is a core component of a complex system consisting of hardware and software that is capable of performing its function discretely from other portions of the entire complex system but designed to interact with the other portions of the entire complex system.

Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

What is claimed is:

1. A cloud security platform configured to protect a cloud environment, comprising:
a cloud analysis logic configured to (i) identify one or more security threats associated with a code submission for evaluation and (ii) generate a message including information associated with the one or more security threats; and
a cloud security system communicative coupled to the cloud analysis logic, the cloud security system is configured to determine a difference between the one or more security threats associated with the code submission and at least one security threat associated with a prior code submission or production code that pertains, at least in part, to the code submission, wherein the difference causes the cloud security system to refrain from release of code included in the code submission as production code; and
where instructions implemented in software for the cloud security system and the cloud security system are configured to be stored in one or more non-transitory storage mediums to be executed by one or more processing units.

2. The cloud security platform of claim 1, wherein the code submission is infrastructure as code (IaC) code and the code analysis logic is a component of a Continuous Integration and Continuous Deployment (CI/CD) pipeline.

3. The cloud security platform of claim 2, wherein the code analysis logic comprises scanning logic configured to scan the IaC code for security threats that pertain to an analysis of information associated with the IaC code including an entity that uploaded the IaC code into the CI/CD pipeline and contents of the IaC code including one or more misconfigurations or vulnerabilities identified within the contents of the IaC code.

4. The cloud security platform of claim 3, wherein the code analysis logic further comprises link detection logic communicatively coupled to the scanning logic, the link detection logic is configured to determine, based on a code identity associated with the IaC code, existing or proposed cloud components affected by the IaC code.

5. The cloud security platform of claim 4, wherein the cloud security system comprises scanning ingestion logic communicatively coupled to the scanning logic and the link detection logic, the scanning ingestion logic is configured to (i) identify a cloud identity based on both the code identity and metadata included in the message from the code analysis logic, and (ii) generate a mapping that includes at least information associated with the one or more security threats and the cloud identity,
wherein the cloud identity operates to identify one or more cloud components within the cloud environment protected by a cyber security platform affected by the one or more security threats.

6. The cloud security platform of claim 5, wherein the cloud security system further comprises security threat assessment logic configured to conduct a comparison between the mapping and one or more mappings associated with prior evaluations of code associated with the cloud identity including production code directed to the one or more cloud components associated with the cloud identity.

7. The cloud security platform of claim 6, wherein the cloud security system further comprises graph builder logic to generate a visualization of the one or more cloud components to be rendered by a graphical user interface (GUI) control unit deployed within a cyber security appliance.

8. The cloud security platform of claim 1, further comprising a cyber security appliance communicatively coupled to the cloud, the cyber security appliance is configured to provide a mapping including at least information associated with the one or more security threats for training of artificial intelligence (AI) models utilized for identifying security threats associated with network communications over a network communicatively coupled to the cloud environment.

9. The cloud security platform of claim 1, wherein the cloud security system is configured to communicate with security services each adapted to protect a corresponding cloud network, the cloud security system is configured to collect information associated with security threats pertaining to cloud environments within the corresponding cloud network to validate findings regarding the one or more security threats by the cloud service system.

10. A computerized method for cloud security, comprising:
identifying one or more security threats associated with a code submission for evaluation;
determining a difference between the one or more security threats associated with the code submission and one or more security threats associated with a prior code submission or production code that pertains, at least in part, to cloud infrastructure modified or created by the code submission;
determining whether the one or more security threats associated with the code submission and the one or more security threats associated with the prior code submission or the production code causes further analysis of content of code included in the code submission prior to release as production code.

11. The computerized method of claim 10, wherein the code submission is infrastructure as code (IaC) code.

12. The computerized method of claim 11, wherein the identifying of the one or more security threats is conducted by code analysis logic within a Continuous Integration and Continuous Deployment (CI/CD) pipeline.

13. The computerized method of claim 12, wherein the one or more security threats pertain to (i) information associated with the IaC code including an entity that uploaded the IaC code into the CI/CD pipeline and (ii) contents of the IaC code that include one or more misconfigurations or vulnerabilities identified within the contents of the IaC code.

14. The computerized method of claim 13, wherein the identifying of the one or more security threats comprises determining existing or proposed cloud components affected by the IaC code.

15. The computerized method of claim 14, further comprising:
identifying a cloud identity corresponding to a code identity of the IaC code; and
generating a mapping that includes at least information associated with the one or more security threats and the cloud identity, wherein the cloud identity operates to identify one or more cloud components within the cloud infrastructure affected by the one or more security threats associated with a code submission.

16. The computerized method of claim 15, further comprising:
conducting a comparison between the mapping and one or more mappings associated with prior evaluations of code associated with the cloud identity including production code directed to the one or more cloud components within the cloud infrastructure.

17. The computerized method of claim 16, further comprising:
generating a visualization of the one or more cloud components to be rendered by a graphical user interface (GUI) control unit deployed within a cyber security appliance.

18. A non-transitory storage medium including software that, when executed by one or more processors, causes operations to determine whether a code submission can proceed to production code, the software comprising:
a cloud analysis logic configured to (i) identify one or more security threats associated with a code submission for evaluation and (ii) generate a message including information associated with the one or more security threats; and
a cloud security system communicative coupled to the cloud analysis logic, the cloud security system is configured to determine a difference between the one or more security threats associated with the code submission and at least one security threat associated with a prior code submission or production code that pertains, at least in part, to the code submission,
wherein the difference causes the cloud security system to refrain from release of code included in the code submission as production code.

19. The non-transitory storage medium of claim 18, wherein the code submission is infrastructure as code (IaC) code and the code analysis logic is a component of a Continuous Integration and Continuous Deployment (CI/CD) pipeline.

20. The non-transitory storage medium of claim 18, further comprising:
scanning ingestion logic configured to (i) identify a cloud identity based on code identity and metadata included in the message, and (ii) generate a mapping that includes at least information associated with the one or more security threats and the cloud identity, wherein the cloud identity operates to identify one or more cloud components affected by the one or more security threats; and
security threat assessment logic configured to conduct a comparison between the mapping and one or more mappings associated with prior evaluations of code associated with the cloud identity including production code directed to the one or more cloud components associated with the cloud identity, wherein the comparison identifies differences between the mapping and the one or more mappings to indicate whether additional security threats are caused by the code submission.
